(19) United States
(12) Patent Application Publication
(10) Pub. No.: US 2004/0262813 A1
(43) Pub. Date: Dec. 30, 2004

(54) Injection molding systems and methods

(75) Inventors: David E. Pierick, San Diego, CA (US); Levi A. Kishbaugh, Groveland, MA (US); Jingyi Xu, York, PA (US); Juan C. Cardona, Lowell, MA (US); Himanshu R. Sheth, N. Andover, MA (US); Kevin J. Levesque, Andover, MA (US); Jeffrey L. Ng, Framingham, MA (US); Roland Y. Kim, Andover, MA (US)

Correspondence Address: Timothy J. Oyer, Ph.D., Wolf, Greenfield & Sacks, P.C., 600 Atlantic Avenue, Boston, MA, 02210, US

(73) Assignee: Trexel, Incorporated, Woburn, MA

(21) Appl. No.: 10/701,118

(22) Filed: Nov. 4, 2003

Related U.S. Application Data
(63) Continuation of application No. PCT/US02/14154, filed on May 6, 2002.
(60) Provisional application No. 60/288,717, filed on May 4, 2001.

(51) Int. Cl. B29C 45/00

(52) U.S. Cl. 264/328.1; 425/145; 425/585

(57) ABSTRACT

Systems and methods for injection molding polymeric materials are provided. The systems and methods use a supercritical fluid additive. In some cases, the use of supercritical fluid additive enables formation of molded articles with low clamping forces and/or low injection pressures. Low clamping forces and/or low injection pressures may reduce the cost of a system designed to form a particular molded article. In some embodiments, the systems may include a control system that controls the operation of one or more components of the system (e.g., the extruder or the supercritical fluid additive introduction system). The systems and methods are suitable for forming polymeric foam articles including microcellular material articles.

### RELATED APPLICATIONS

This application is a continuation of International Application Ser. No. PCT/US02/14154, filed on May 6, 2002, which was published under PCT Article 21(2) in English, and claims priority to U.S. Provisional Patent Application Ser. No. 60/288,717, filed May 4, 2001, the disclosures of which are incorporated herein by reference.

### FIELD OF INVENTION

The invention relates generally to polymer processing and, more particularly, to injection molding systems and methods used to process polymeric materials using a supercritical fluid additive.

### BACKGROUND OF INVENTION

Polymeric materials may be processed to form articles having a number of different shapes and sizes. Conventional polymer processing techniques include injection molding, extrusion, and blow molding. Injection molding techniques generally involve forming a fluid stream of polymeric material in an extruder, injecting the fluid polymeric material into a mold cavity defined between mold halves, cooling the fluid polymeric material to form a molded article, and opening the mold halves to remove the article.

Injection molding systems are designed, in part, to be compatible with the molding process. For example, molding systems are designed to be compatible with the high pressures that exist within the extruder barrel and in the mold, when polymeric material is injected into the mold. In particular, molding systems are designed to provide a sufficient clamping force that holds the mold halves together during polymeric injection. Generally, at least a minimum clamping force is needed (for a given article or mold cavity) to form high quality molded articles. Clamping the mold with a low force, for example, can result in flashing of polymeric material between mold halves. Injection molding systems are also designed to provide a sufficient injection pressure to inject polymeric material into the mold cavity. Generally, at least a minimum injection pressure is needed to fill the mold cavity in a way that forms high quality molded articles.

The cost of an injection molding system depends, in part, on the design of its components. Generally the cost of a particular system increases as the clamping force requirements increase and/or the injection pressure requirements increase. To provide a higher clamping force, for example, a larger, more expensive clamping device is required which has a higher flow rate hydraulic system. Similarly, to provide a higher injection pressure, a larger, more expensive injection device is required. To reduce cost, therefore, it is desirable to reduce the clamping force requirement and/or injection pressure requirement of a system to form a molded article.

### SUMMARY OF INVENTION

The invention provides systems and methods for injection molding polymeric materials.

In one aspect, the invention provides a system for injection molding polymeric material. The system includes an extruder including a screw rotatable within a barrel to convey polymeric material in the direction of an outlet of the extruder. The barrel has a port formed therein connectable to a source of supercritical fluid additive. The system further includes a clamping device constructed and arranged to clamp a mold that defines a cavity connectable to the outlet of the extruder. The clamping device is capable of providing a maximum clamping force of no greater than about 80% the minimum clamping force necessary to form an article from polymeric material free of a supercritical fluid additive within the cavity.

In another aspect, the invention provides a system for injection molding polymeric material. The system includes an extruder including a screw rotatable within a barrel to convey polymeric material in the direction of an outlet of the extruder. The barrel has a port formed therein connectable to a source of supercritical fluid additive. The system further includes a mold including a mold surface that defines, in part, a cavity connected to the outlet of the extruder. The mold surface that defines, in part, the cavity has a mold surface area. The system further includes a clamping device constructed and arranged to clamp the mold with a clamping force necessary to form a molded article. The ratio of the clamping force to the mold surface area is less than about 1500 lbs/in².

In another aspect, the invention provides a system for injection molding polymeric material. The system includes an extruder including a screw rotatable within a barrel to convey polymeric material in the direction of an outlet of the extruder. The barrel having a port formed therein connectable to a source of supercritical fluid additive. The system further includes a clamping device constructed and arranged to clamp a first mold half and a second mold half together with a clamping force. The first and second mold halves, when clamped together, define a cavity connected to the outlet of the extruder. The system further including a first platen attachable to the first mold half, and a second platen attachable to the second mold half. The first and the second platens have a work surface area at least 10% greater than the work surface area of platens usable to form an article from polymeric material free of a supercritical fluid additive within the cavity clamped with the clamping force.

In another aspect, the invention provides a system for injection molding polymeric material. The system includes an extruder including a screw rotatable within a barrel to convey polymeric material in the direction of an outlet of the extruder. The barrel having a port formed therein connectable to a source of supercritical fluid additive. The system further includes an injection device constructed and arranged to move the screw in an axial direction within the barrel to inject a mixture of polymeric material and supercritical fluid additive into a cavity of a mold connected to the outlet of the extruder. The injection device is capable of providing an injection pressure of no greater than about 80% the injection pressure necessary to form an article from polymeric material free of a supercritical fluid additive within the cavity.

In another aspect, the invention provides a system for injection molding polymeric material. The system includes an extruder including a screw rotatable within a barrel to convey polymeric material in the direction of an outlet of the extruder. The barrel has a port formed therein connectable to a source of supercritical fluid additive. The system further includes an injection device constructed and arranged to move the screw in an axial direction within the barrel to inject a mixture of polymeric material and supercritical fluid additive into a cavity of a mold connected to the outlet of the extruder. The injection device is capable of providing an injection pressure of no greater than about 80% the injection pressure necessary to form an article from polymeric material free of a supercritical fluid additive within the cavity. The system further includes a clamping device constructed and arranged to clamp the mold. The clamping device is capable of providing a maximum clamping force of no greater than about 80% the minimum clamping force necessary to form an article from polymeric material free of a supercritical fluid additive within the cavity.

In another aspect, the invention provides a system for processing polymeric material. The system includes an extruder including a screw rotatable within a barrel to convey polymeric material in the direction of an outlet of the extruder, the barrel having a port formed therein. The system further includes a supercritical fluid additive introduction system having an inlet connectable to a supercritical fluid additive source and an outlet connectable to the port. The introduction system is directly mounted to the system.

In another aspect, the invention provides a polymeric material processing system. The system includes an extruder including a screw rotatable within a barrel to convey polymeric material in the direction of an outlet of the extruder. The barrel has a port formed therein. The system further includes a supercritical fluid additive introduction system having an inlet connectable to a supercritical fluid additive source and an outlet connectable to the port. The system further includes a control system. The control system is designed to receive inputs from the extruder and the supercritical fluid additive introduction system, and is designed to send outputs to the extruder and the supercritical fluid additive introduction system to control, in part, operation of the extruder and the supercritical fluid additive introduction system.

In another aspect, the invention provides a method for forming a molded article. The method includes providing a polymeric material molding system including an extruder and a mold, the system constructed and arranged to deliver polymeric material free of supercritical fluid additive from the extruder into the mold and forming an injection molded article using a first minimum clamping force. The method further includes delivering polymeric material admixed with a supercritical fluid additive from the extruder into the mold, and forming the injection molded article using a second minimum clamping force less than about 80% the first minimum clamping force.

In another aspect, the invention provides a method for forming a molded article. The method includes introducing a polymeric material and supercritical fluid additive mixture into a mold. The method further includes clamping the mold with a clamping force of less than about 80% of the minimum clamping force required to form a molded article from the polymeric material free of the supercritical fluid additive, and forming a molded article.

Other advantages, aspects, and features of the invention will become apparent from the following detailed description of the invention when considered in conjunction with the accompanying drawings.

### BRIEF DESCRIPTION OF DRAWINGS

FIGS. 1A to 1C show an injection molding system according to one embodiment of the present invention at different stages during the molding cycle.

FIGS. 2A and 2B are exploded views of the injection mold and the clamping device of the injection molding system according to one embodiment of the present invention.

FIG. 3 illustrates the mold surface area and mold wall thickness of a mold used in the injection molding system according to one embodiment of the invention.

FIGS. 4A and 4B respectively illustrate the work surface area and the thickness of a platen used in the injection molding system according to one embodiment of the invention.

FIG. 5 illustrates a supercritical fluid additive introduction system directly mounted to the injection molding system according to another embodiment of the invention.

### DETAILED DESCRIPTION OF INVENTION

Systems and methods for injection molding polymeric materials are provided. The systems and methods use a supercritical fluid additive. In some cases, the use of supercritical fluid additive enables formation of molded articles with low clamping forces and/or low injection pressures. Low clamping forces and/or low injection pressures may reduce the cost of a system as compared to conventional systems designed to form a particular molded article. In some embodiments, the systems may include a control system that controls the operation of one or more components of the system (e.g., the extruder or the supercritical fluid additive introduction system). The systems and methods are suitable for forming polymeric foam articles including microcellular material articles.

As used herein, the term “clamping force” refers to the force that holds together the two mold halves which define the mold cavity. The clamping force can be determined, for example, by multiplying the hydraulic pressure by the piston surface area in a clamping device (for hydraulic clamping devices); or, by measuring the force using a load cell associated with the mold halves and/or platens; or, by measuring tie bar elongation or strain and converting to a clamping force.

As used herein, the term “injection pressure” refers to the pressure at which polymeric material is injected into the mold. The injection pressure can be determined, for example, by measuring the hydraulic load (for hydraulic injection systems), or by measuring the servomotor torque and multiplying it by the appropriate mechanical advantage factor of the system (for electrical injection systems).

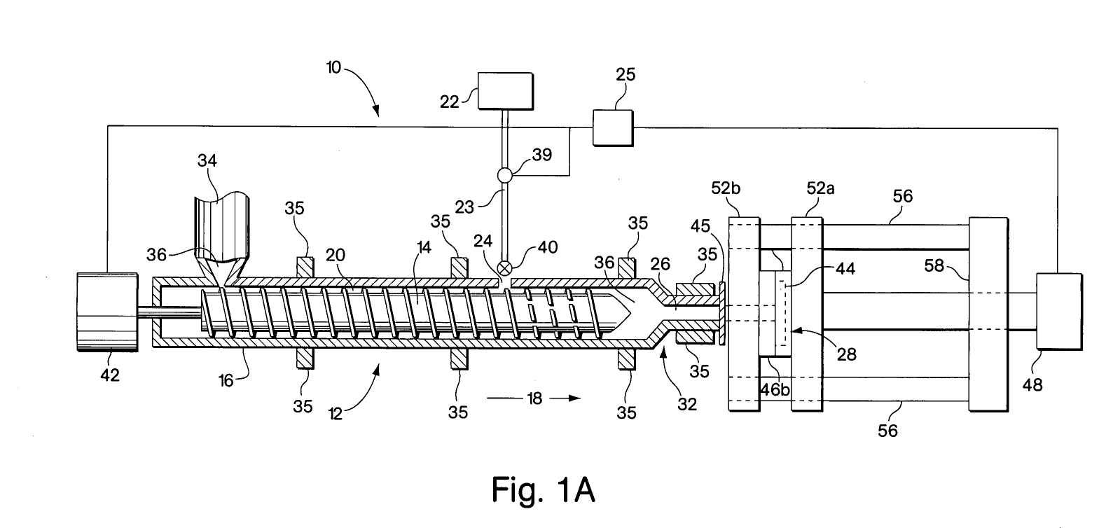

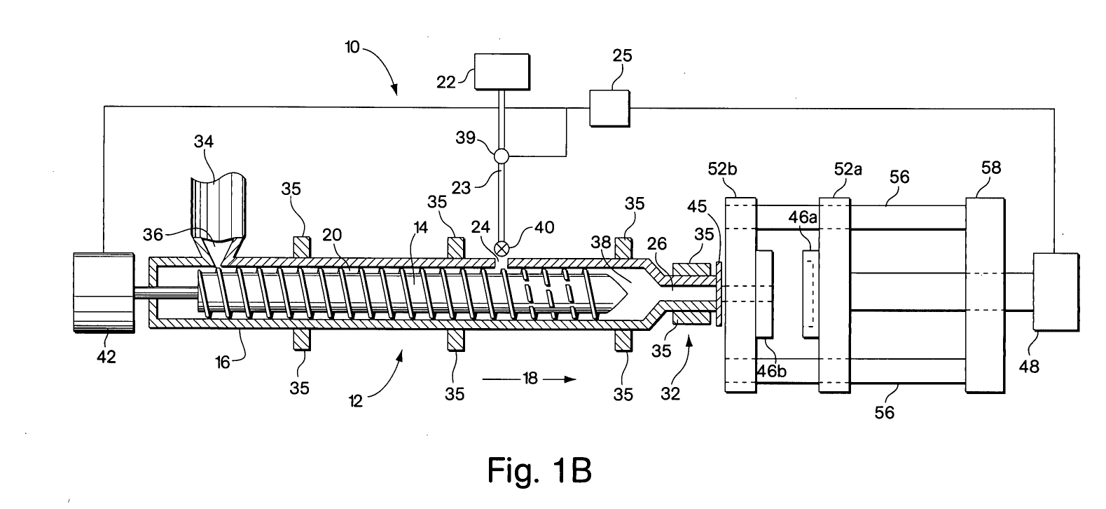

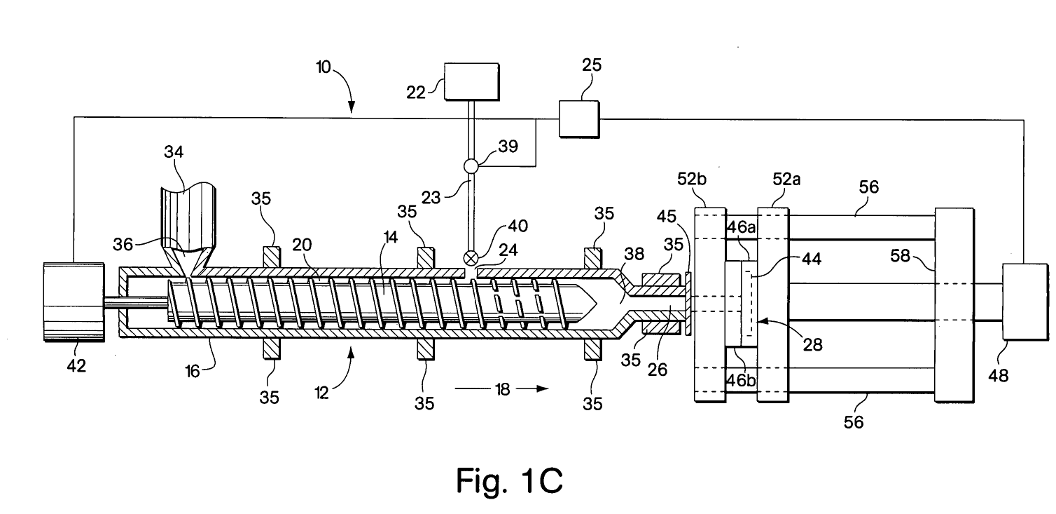

As used herein, the term “supercritical fluid additive” refers to any additive that is a supercritical fluid under temperature and pressure conditions within an extruder (12, FIG. 1) of an injection molding system. It should be understood that the supercritical fluid additive may or may not be a supercritical fluid prior to introduction into the extruder (e.g., when supercritical fluid additive is in source 22, FIG. 1) and that the additive may be introduced into the polymeric material in the extruder in any flowable state, for example, as a gas, liquid, or supercritical fluid.

FIGS. 1A-1C schematically illustrate an injection molding system 10 according to one embodiment of the present invention. An extruder 12 of molding system 10 includes a polymer processing screw 14 that is rotatable within a barrel 16 to convey polymeric material in a downstream direction 18 within a polymer processing space 20 defined between the screw and the barrel. The system includes a supercritical fluid additive introduction system 21 for introducing the supercritical fluid additive into the polymeric material thereby forming a mixture of polymeric material and supercritical fluid additive in polymer processing space 20. Supercritical fluid additive introduction system 21 includes a source 22 of supercritical fluid additive that is connected via conduit 23 to a port 24 formed within the barrel. Extruder 12 includes an outlet 26 connected to an injection mold 28. Optionally, system 10 includes a control system 25 that is capable of controlling the injection molding process and/or supercritical fluid additive introduction into the polymeric material. The supercritical fluid additive lowers the viscosity of the mixture which permits forming molded articles using low clamping forces and/or low injection pressures, as described further below.

Generally, injection molding system 10 operates cyclically to produce multiple molded articles. At the beginning of a typical molding cycle, screw 14 is positioned at a downstream end 32 of barrel 16. Polymeric material, typically in pelletized form, feeds into polymer processing space 20 from a hopper 34 through an orifice 36. Barrel 16 may be heated by one or more heating units 35. Screw 14 rotates to plasticate polymeric material and to convey the polymeric material in downstream direction 18. Polymeric material is generally in a fluid state at the point of supercritical fluid additive introduction. The flow rate of supercritical fluid additive into the polymeric material may be metered, for example, by a metering device 39 positioned between source 22 and port 24. As described further below, metering device 39 may also be connected to control system 25 which sends signals to control supercritical fluid additive flow rate. The mixture of polymeric material and supercritical fluid additive is conveyed downstream by the rotating screw and accumulated in a region 38 (FIG. 1B) within the barrel downstream of the screw. The accumulation of the mixture in region 38 creates a pressure that forces the screw axially in an upstream direction in the barrel. After a sufficient charge of the mixture has been accumulated, screw 14 ceases to rotate (which stops the plastication of polymeric material) and stops moving in the upstream direction (FIG. 1C). Preferably, when the screw no longer plasticates polymeric material the introduction of supercritical fluid additive into the polymeric material is, or has been, stopped, for example, by the operation of an injector valve 40 associated with port 24.

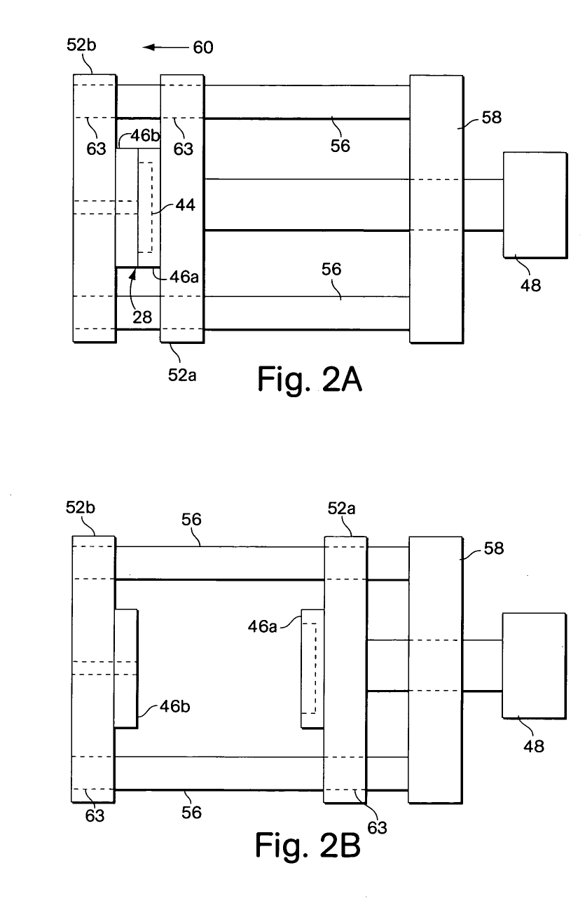

Then, the screw is moved axially in a downstream direction by an injection device 42 to downstream end 32 of the barrel, returning to the screw position in FIG. 1A, to inject the accumulated charge of the mixture through outlet 26 of the extruder and into a cavity 44 defined between mold halves 46a, 46b via a passageway 47. A shut-off nozzle valve 45 associated with the outlet of the extruder typically is opened to permit the mixture to flow into the cavity. After the charge is injected into the cavity, valve 45 is typically closed. As described further below and shown in FIGS. 2A and 2B, a clamping device 48 holds mold halves 46a, 46b of the mold together during injection and the subsequent cooling of the polymeric material. After the polymeric material sufficiently solidifies, clamping device 48 separates mold halves 46a, 46b to open mold 28 and to eject a molded article. In the illustrative embodiment, mold 28 is opened during the accumulation of the mixture of polymeric material and blowing agent in region 38 downstream of screw 14 (FIG. 1B). The molding cycle is repeated to produce additional molded articles.

It should be understood that molding system 10 may include a number of variations from the illustrative embodiment as known to one of ordinary skill in the art. For example, mold 28 may define more than one cavity in which articles may be molded and may include a hot runner gate to introduce polymeric material into the cavities. The hot runner gate may also be provided with a valve to selectively control introduction of the polymeric material. It should also be understood that the injection molding system may be a hydraulic system, an electrical system, or a hybrid hydraulic/electric system.

Control system 25, when provided, may receive input signals from and send output signals to one or more components of the injection molding system. The control system may also receive manual input signals in response to entries by an operator. In particular, control system 25 may be used to synchronize the operation of the injection molding system and supercritical fluid additive introduction. For example, control system 25 can coordinate the operation of metering device 39 with screw 14 so that a desired amount of supercritical fluid additive is introduced into the polymeric material to form a mixture having the desired weight percentage of supercritical fluid additive, as described further below. In some embodiments, a first controller controls the operation of the injection molding system and a second controller controls supercritical fluid additive introduction. In other embodiments, a single controller controls operation of the injection molding system and supercritical fluid additive introduction. The operation of the control system is described further below. Suitable control systems have been further described in commonly-owned, co-pending U.S. patent application Ser. No. (not yet assigned), entitled “Method and Apparatus for Controlling Foam Molding Processing”, by Kim et. al., filed on Apr. 5, 2001, which is incorporated herein by reference.

Referring to FIGS. 2A and 2B, injection mold 28 and clamping device 48 are shown according to one embodiment of injection molding system 10. In the illustrative embodiment, mold half 46a is secured to a movable platen 52a, and mold half 46b is secured to a fixed platen 52b. Platen 52a is slidably mounted on a plurality of tie bars 56 which extend from a backside 58 of system 10 to fixed platen 52b. Platen 52a reciprocates on tie bars 56 to open and close mold 28 in response to the action of clamping device 48 which is synchronized with the molding cycle. Mold 28 is closed when clamping device 48 pushes platen 52a in the direction of arrow 60 which forces mold half 46a against mold half 46b (FIG. 2A). As described above, clamping device 48 holds mold halves 46a, 46b together with a clamping force during injection and while the polymeric material cools. To open the mold, clamping device retracts platen 52a in a direction opposite arrow 60 which separates mold halves 46a, 46b (FIG. 2B).

It should be understood that other configurations of the injection mold and clamping device may also be used in connection with the systems and methods of the invention. For example, in some cases, systems and methods of the invention may not include platens. In these cases, the movable mold half may be secured directly to the clamping device and the other mold half secured to the frame of the system. Eliminating platens from the system can result in large cost savings. In other embodiments, a pressure measuring device may be associated with mold cavity 44 to monitor pressure within the mold (i.e., cavitation pressure). The pressure measuring device may, for example, access the mold cavity through a wall of one of the mold halves. The pressure measuring device can send output signals representative of the cavitation pressure, for example, to control system 25 to control various molding parameters such as injection speed and injection force, amongst others.

Clamping device 48 may be any suitable type. Clamping device 48 may be hydraulically or mechanically/electrically powered. A clamping device can be characterized by the maximum force it is capable of providing. Suitable clamping devices may provide a maximum force, for example, of between about 10 tons and about 10,000 tons, and more typically between about 30 tons and about 3,000 tons. The specific clamping force depends upon the article being molded amongst other factors. Generally, the cost of a clamping devices is proportional to the maximum force it can apply (i.e., the greater the maximum force, the greater the cost).

Clamping device 48 generally needs to provide a minimum clamping force to form a high quality molded article. Thus, clamping device 48 is capable of providing a maximum force greater than the minimum force required to form the desired article. The minimum clamping force, for example, is defined as the clamping force sufficient to prevent polymeric material injected into cavity 44 from flashing between mold halves 46a, 46b. The minimum clamping force required depends upon several factors including the cavity shape and cavity dimensions used to form the article.

As described above, the addition of the supercritical fluid additive can lower the minimum clamping force required to form a molded article. The lowering of the clamping force results from the ability of the supercritical fluid additive to reduce the viscosity of the polymeric material which leads to lower cavitation pressures (i.e., the pressure of polymeric material within mold cavity 44). The invention includes the realization that processing with the supercritical fluid additive to form a molded article permits using clamping devices that provide lower maximum forces than the minimum force necessary to form the article when processing without the supercritical fluid additive. The reduction in required clamping force depends, in part, upon the amount of supercritical fluid additive in the mixture. In some embodiments, system 10 forms a molded article from the polymeric material and supercritical fluid additive mixture using clamping device 48 which provides a maximum clamping force of less than about 80% the minimum clamping force necessary to form the same article from polymeric material free of a supercritical fluid additive. In this context, the article formed from polymeric material free of supercritical fluid additive has substantially the same quality, external appearance, dimensions and polymeric composition as the article formed using the mixture of polymeric material and supercritical fluid additive. However, in some cases, the article formed using the mixture may be a polymeric foam, while the article formed using polymeric material free of supercritical fluid additive may be a solid polymer. In other embodiments, even greater reductions in clamping force can be utilized. For example, system 10 may form a molded article from the polymeric material and supercritical fluid additive mixture using clamping device 48 which provides a maximum clamping force of less than about 65%, less than about 50%, less than about 30%, or even less than about 10%, the minimum clamping force necessary to form the same article from polymeric material free of a supercritical fluid additive. The reduction in necessary clamping force enables articles to be formed using injection molding systems that may be significantly less expensive than systems used to form the same articles without the supercritical fluid additive.

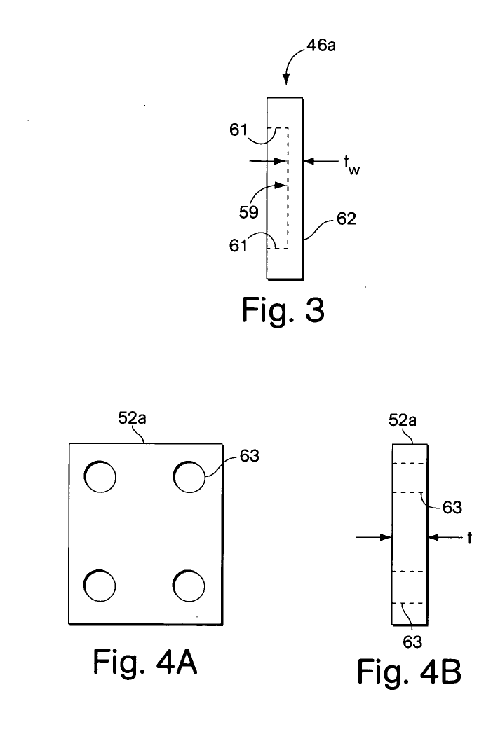

The reduction in clamping force necessary to form a molded article can also be measured with respect to the mold surface area. FIG. 3 schematically illustrates the mold surface area A of mold cavity 44 according to one embodiment of the present invention. As used herein, the term “mold surface area” is defined as the surface area of a back surface 59 (i.e., a surface generally perpendicular to the flow of polymeric material into the mold cavity) of cavity 44. The mold surface area does not include side surfaces 61 of mold cavity 44. The ratio of clamping force to mold surface area generally must be greater than a minimum value to ensure the formation of high quality molded articles. Generally, conventional molding systems and methods use clamping force to mold surface area ratios of greater than about 2000 lbs/in². In systems and methods of the invention, lower ratios may be utilized. For example, the systems and methods of the invention can have ratios of clamping force to mold surface area of less than about 1500 lbs/in². In other cases, the ratio of clamping force to mold surface area is less than about 1000 lbs/in². Even lower ratios of less than about 750 lbs/in², or less than about 500 lbs/in² may also be used. Ratios may be decreased, for example, by increasing the amount of the supercritical fluid additive in the mixture. In some cases, lower ratios may be desired because they are indicative of greater cost savings associated with clamping device 48 and, in turn, injection molding system 10.

The supercritical fluid additive also permits using platens 52a, 52b that have large work surface areas. As used herein, the term “work surface area” of a platen refers to the surface area on a platen to which a mold half can be secured. FIG. 4A illustrates a work surface area A′ of platens 52a, 52b. The work surface area generally includes the entire surface area of the platen but does not include holes 63 formed in the platens through which tie bars 56 extend (FIG. 2A-2B). Generally, the work surface area of a platen is limited to a maximum value for a fixed clamping force. Using platens with too large work surface areas for a fixed clamping force can result in the formation of unsatisfactory molded articles, in part, due to flashing of polymeric material between mold halves. In particular, platens of systems and methods of the invention may have work surface areas that are greater than the work surface areas of platens (for a fixed clamping force) used in conventional systems and methods that do not utilize supercritical fluid additives. Larger work surface area platens may be used, in part, because the work space between tie bars can be increased and/or tie bar diameter can be decreased.

In some cases, the systems and methods may use platens having at least about 10% greater work surface areas for a fixed clamping force than platens used in systems and methods that do not use supercritical fluid additives. In some cases, the systems and methods may use platens having at least about 30% greater work surface area, or even at least about 50% greater work surface area, for a fixed clamping force than platens used in systems and methods that do not use supercritical fluid additives. Increasing the work surface area of the platen enables mold cavities with larger areas to be used and, thus, permits molding of articles with larger areas. The amount of increase in work surface area depends, in part, on the amount of supercritical fluid additive in the mixture.

The supercritical fluid additive also permits using the systems and methods of the invention with platens that are relatively thin and/or less rigid. Thin or less rigid platens can be used because of the reduction in cavitation pressure. FIG. 4B illustrates a thickness t of platen 52a. In particular, platens 52a, 52b may be made thinner than platens used to form the same article without the supercritical fluid additive at a fixed clamping force. For example, platens 52a, 52b may be made greater than about 10% thinner, or even greater than about 20% thinner, than platens used to form the same molded article without the supercritical fluid additive at a fixed clamping force. Decreasing platen thickness can reduce the mass of the platen which permits using smaller and lighter actuators and/or a smaller (i.e., capable of supporting less weight) frame which supports the clamping device. The reduced mass also allows the platen to be moved more rapidly by a given force and, thus, allows for shorter cycle times.

The supercritical fluid additive also permits using mold halves 46a, 46b that have relatively thin walls 62 (FIG. 3). Thin walls 62 can be used because of the reduction to cavitation pressure. In particular, mold walls 62 may be made thinner than mold walls used to form a given article without the supercritical fluid additive at a fixed clamping force. For example, mold walls 62 may be made greater than about 10% thinner, or even greater than about 20% thinner, than mold walls used to form a given molded article without the supercritical fluid additive at a fixed clamping force. Thinner mold walls enhance the ability of a mold to be cooled, for example via water cooling, which can lead to shorter cycle times and increased productivity.

Using the supercritical fluid additive also may enable forming mold halves 46a, 46b of less expensive materials than used in certain conventional systems that do not utilize the supercritical fluid additive. Typically, mold halves 46a, 46b are formed of relatively expensive high strength steels to withstand high cavitation pressures and to have long usable lives. Because cavitation pressures are lowered in the systems and methods of the invention, in some cases, mold halves 46a, 46b may be formed of materials that are not as strong (and expensive) as high strength steel, such as aluminum. Such mold halves 46a, 46b can provide similar performance using less expensive material. Mold halves 46a, 46b made of aluminum are more easily machined and also may be cooled quickly more quickly than steel due to the high thermal conductivity of aluminum. Therefore, cycle times may be reduced when using aluminum mold halves 46a, 46b which can increase productivity.

The supercritical fluid additive can also result in lower injection pressures than conventional systems and methods which do not utilize the supercritical fluid additive. The lower injection pressures can be achievable because the supercritical fluid additive reduces the viscosity of the polymeric material. When injection velocity is held substantially constant, typical injection pressures in the systems and methods of the present invention are between about 500 psi and about 10,000 psi, while conventional systems and methods which do not utilize the supercritical fluid additive are between about 5,000 psi and about 30,000 psi. The specific injection pressure depends on a variety of factors including material type, processing conditions, and dimensions of extruder outlet 26 and mold cavity 44. In some embodiments, systems 10 can form a molded article by injecting a mixture of polymeric material and supercritical fluid additive into cavity 44 at an injection pressure of less than about 80% the injection pressure necessary to form the same article from polymeric material free of a supercritical fluid additive. In other embodiments, even greater reductions in injection pressure can be achieved. For example, system 10 can form a molded article by injecting a mixture of polymeric material and supercritical fluid additive into cavity 44 at an injection pressure of less than about 65%, or even less than about 50%, the injection pressure necessary to form the same article from polymeric material free of a supercritical fluid additive. The amount that the injection pressure is lowered depends, in part, on the amount of supercritical fluid additive present in the mixture. The lower injection pressures may also enable increased injection velocity which can improve cycle time and process performance.

Lower injection pressures permit using injection devices 42 that provide lower maximum injection force. The cost of injection device 42 generally decreases as the maximum injection force required is reduced. Thus, system 10 may be less expensive when designed to form the same molded article than conventional systems which do not utilize the supercritical fluid additive.

Lower injection pressures also may enable barrel 16 to be made thinner than in conventional systems which do not utilize the supercritical fluid additive. The strength of barrel 16 depends, in part, on its thickness. Generally, a barrel is designed to withstand the peak pressure (e.g., the injection pressure) experienced in the extruder. Thus, reduced injection pressures permit use of a thinner barrel 16 in system 10. Thinner barrels are generally less expensive, thus, resulting in cost savings associated with the systems of the present invention. Also, as a result of the lower injection pressure, it may be possible to drill water channels directly into barrel 16. Such water channels can efficiently cool the polymeric material which is advantageous in certain processes.

Screw 14 may be designed to have a large diameter as a result of the lower injection pressures. For example, screw 14 may be made greater than about 40% larger than the cross-sectional area of a screw used to form a given molded article without the supercritical fluid additive at a fixed clamping force. Larger screw cross-sectional areas enable the faster production of larger shot sizes and larger molded parts by injecting more material into the mold at a quicker rate and allowing faster recovery rates to decrease cycle time.

The lower clamping forces and lower injection pressures may allow systems of the invention to use less power than conventional systems that do not utilize the supercritical fluid additive. Savings in power usage can result in considerable cost savings.

In certain preferred embodiments, the supercritical fluid additive may function as a physical blowing agent which forms cell within the polymeric material article. Typically, the supercritical fluid additive forms the cell via a nucleation step as a result of the pressure drop that occurs when the mixture is injected into mold 28 through outlet 26 of extruder 12. Thus, the systems and methods of the invention can produce polymeric foam articles, including microcellular materials, as described further below. In particular, the systems and methods of the invention may be designed to form microcellular polymeric articles as described in International Publication No. WO 98/31521 (Pierick et. al.) which is incorporated herein by reference. However, in other cases, the systems and methods of the invention may form solid polymeric articles without any cells. In these cases, the supercritical fluid additive functions as a viscosity lowering aid, but not as a blowing agent that nucleates and grow cells.

The supercritical fluid additive may have a variety of compositions including nitrogen, carbon dioxide, and mixtures thereof. According to one preferred embodiment, the supercritical fluid additive is carbon dioxide. In another preferred embodiment the supercritical fluid additive is nitrogen. In certain embodiments, the supercritical fluid additive is solely carbon dioxide or nitrogen. In embodiments in which supercritical fluid additive is nitrogen, source 22 may be a nitrogen generator which produces nitrogen from the atmosphere.

As described above, the supercritical fluid additive may be introduced into the polymeric material to provide a mixture having the desired weight percentage. For example, metering device 39 may be used in conjunction with control system 25 to provide the desired percentage. The desired weight percentage of supercritical fluid additive may depend upon a number of factors including the extent of viscosity reduction. Generally, increasing the weight percentage of the supercritical fluid additive in a mixture will further decrease the viscosity. However, increasing the weight percentage of the supercritical fluid additive may have other processing effects such as resulting in process instability, amongst others. The supercritical fluid additive percentage is typically less than about 10% by weight of the mixture of polymeric material and supercritical fluid additive. In some embodiments, the supercritical fluid additive level is less than about 5%. In many cases, it may be preferable to use low weight percentages of supercritical fluid additive. For example, the supercritical fluid additive level may be less than about 3%, in others less than about 1%, and still others less than about 0.1% by weight of polymeric material and supercritical fluid additive mixture. The supercritical fluid additive level may also depend upon the type of supercritical fluid additive used. For example, to achieve the same reduction in viscosity, carbon dioxide typically has to be added at greater amounts than nitrogen.

The supercritical fluid additive introduction rate may be coupled, for example by control system 25, to the flow rate of polymeric material to produce a mixture having the desired weight percentage. Supercritical fluid additive may be introduced into the polymeric material over a wide range of flow rates. In some embodiments, the supercritical fluid mass flow rate into the polymeric material may be between about 0.001 lbs/hr and about 100 lbs/hr, in some cases between about 0.002 lbs/hr and about 60 lbs/hr, and in some cases between about 0.02 lbs/hr and about 10 lbs/hr.

In some embodiments, the system includes a bypass valve positioned between source 22 and port 24. When the bypass valve is in one configuration, the flow of blowing agent from the source to the port is diverted through the bypass valve and, optionally, a bypass passageway connected to the outlet of the valve. The blowing agent may be, for example, diverted through the bypass valve and released to the atmosphere or re-introduced to source 22. When the bypass valve is in a second configuration, blowing agent may flow from the source to the port. Suitable bypass valve designs and arrangements have been described in co-pending, commonly-owned, U.S. application Ser. No. 09/782,673, filed Feb. 13, 2001, entitled “Blowing Agent Delivery System”, which is incorporated herein by reference. The presence of a bypass valve may be particularly useful when it is desired to have constant blowing agent flow from the source, for example, to increase the stability of blowing agent flow. In some embodiments, the bypass valve may be combined with injector valve 40 in a single device. In other embodiments, the bypass valve may be a separate device than the injector valve.

In some embodiments, particularly when forming microcellular materials, it may be preferable to form a single-phase solution of polymeric material and supercritical fluid additive within polymer processing space 20. That is, the mixture of polymeric material and supercritical fluid additive is a single-phase solution. In certain embodiments, it may be preferable to maintain the single-phase condition until the solution is injected into mold 28. To aid in the formation of a single-phase solution, supercritical fluid introduction may be done through a plurality of ports 24 arranged in the barrel, though it should be understood that a single port may also be utilized to form a single-phase solution. When multiple ports 24 are utilized, the ports can be arranged radially about the barrel or in a linear fashion along the axial length of the barrel. An arrangement of ports along the length of the barrel can facilitate injection of supercritical fluid additive at a relatively constant location relative to the screw when the screw moves axially (in an upstream direction) within the barrel as the mixture of polymeric material and supercritical fluid additive is accumulated. Where radially-arranged ports are used, ports 24 may be placed at the 12:00 o'clock, 3:00 o'clock, 6:00 o'clock and 9:00 o'clock positions about the extruder barrel, or in any other configuration as desired. Port 24 may include a single orifice or a plurality of orifices. In the multi-orifice embodiments (not illustrated), the port may include at least about 2, and some cases at least about 4, and others at least about 10, and others at least about 40, and others at least about 100, and others at least about 300, and others at least about 500, and in still others at least about 700 orifices. In another embodiment, port 24 includes an orifice containing a porous material that permits supercritical fluid additive to flow therethrough and into the barrel, without the need to machine a plurality of individual orifices. Suitable port arrangements and designs (including multi-hole orifice designs) are further described in International Publication No. WO 98/31521 (Pierick et. al.), which is referenced above.

To further promote the formation of a single-phase solution, port 24 may be located at a section of the screw that may include full, unbroken flight paths. In this manner, each flight, passes or “wipes” the port including orifices periodically, when the screw is rotating. This wiping increases rapid mixing of supercritical fluid additive and polymeric material in the extruder and the result is a distribution of relatively finely divided, isolated regions of supercritical fluid additive in the polymeric material immediately upon injection into the barrel and prior to any mixing. Downstream of port 24, the screw may include a mixing section which has highly broken flights to further mix the polymeric material and supercritical fluid additive mixture to promote formation of a single-phase solution.

As described above, control system 25 may receive input signals from and send output signals to different components of the injection molding system including components of the extruder, components of the supercritical fluid introduction system, or components of the injection mold. The inputs may be indicative of different processing or equipment conditions. For example, the inputs may be indicative of the configuration of shut-off nozzle valve 45, the axial position of screw 14 within the barrel, the configuration of injector valve 40, the pressure of polymeric material within the barrel, the pressure of polymeric material accumulated in a region within the barrel downstream of the screw, the mass of supercritical fluid additive introduced into the polymeric material, the delivery pressure of supercritical fluid additive introduced into the polymeric material, and the rotational speed of the screw. It should be understood that other inputs are also possible including inputs of additional processing or equipment conditions. Other suitable controller inputs have also been described in U.S. patent application Ser. No. (not yet assigned), entitled “Method and Apparatus for Controlling Foam Molding Processing”, by Kim et. al., filed on Apr. 5, 2001, and incorporated by reference above. The components which send inputs to the control system may be measuring devices (e.g., pressure transducers, and melt or metal thermacouples), or operative devices, themselves (e.g., valves and regulators). The inputs may be used to monitor certain processing or equipment conditions, and/or may be used, at least in part, to determine outputs sent by the control system to control processing or equipment conditions.

In some cases, the operator provides one or more inputs to the control system. The operator may provide an input causing the controller to activate various aspects of process control (e.g., control of polymeric pressure within the extruder, control of injector valve configuration, and the like). In embodiments which include a first controller associated with the extruder and a second controller associated with the supercritical fluid additive system, the operator may provide an input to one of the controllers (e.g., the first controller) and have that controller send a signal to the other controller (e.g., the second controller) indicative of the input.

The output signals are sent by control system 25, for example, to control the operation of different components of the injection molding system which may provide desired processing or equipment conditions. The outputs may control, for example, the configuration of shut-off nozzle valve 45, the operation of heating unit(s) mounted on the barrel, the operation of heating unit(s) associated with the shut-off valve, the configuration of hot runner gate valve(s), the axial position of the screw, the configuration of a bypass valve, the configuration of injector valve(s) 40, the pressure of polymeric material within the barrel, the pressure of polymeric material accumulated in a region within the barrel downstream of the screw, the mass of supercritical fluid additive introduced into the polymeric material, the delivery pressure of supercritical fluid additive introduced into the polymeric material, and the rotational speed of the screw. It should be understood that other outputs are also possible including outputs that control additional processing or equipment conditions. Other suitable controller outputs have also been described in U.S. patent application Ser. No. (not yet assigned), entitled “Method and Apparatus for Controlling Foam Molding Processing”, by Kim et. al., filed on Apr. 5, 2001, and incorporated by reference above.

In some cases, the control system is designed to provide an indication to a operator when certain processing or equipment conditions are present. For example, the control system may indicate to an operator when undesirable, or dangerous, processing or equipment conditions are present so that the operator may adjust conditions accordingly. The control system may alternatively, or in addition to, providing indication to the operator, send an output signal that adjusts conditions accordingly. For example, the control system may send an output to the supercritical fluid additive introduction system so that supercritical fluid additive is not introduced into the polymeric material when certain conditions are present.

The control system may provide indication to an operator and/or send an output to adjust conditions when processing conditions differ from desired conditions by a selected amount. For example, the control system may provide indication or send an output when one of the following processing conditions is present: the pressure of polymeric material within the barrel is greater or less than a desired pressure by an offset value (e.g., ±200 psi), for example, at a control system or user determined time in the molding cycle, the mass of supercritical fluid additive introduced into the polymeric material is greater or less than a desired mass by an offset value (e.g., ±10 mg), or the delivery pressure of supercritical fluid additive introduced into the polymeric material is greater or less than a desired delivery pressure by an offset value (e.g., ±50 psi), for example, at a control system or user determined time in the molding cycle. The desired condition (e.g., polymeric material pressure, mass of supercritical fluid additive, or delivery pressure) and offset value may depend upon the particular process. The desired condition and/or offset value may be selected by the operator at the beginning of the process, or may be permanently programmed into the control system.

In some cases, the control system provides an indication to an operator and/or adjusts conditions when processing conditions (e.g., polymeric material pressure, mass of supercritical fluid additive, or delivery pressure) during a molding cycle differ by a given amount from processing conditions in the previous molding cycle, for example, at a control system or user determined time in the molding cycle.

In some cases, the control system provides an indication to an operator when the injection mold is not closed, when safety gates or doors associated with the injection molding system are open, when the desired supercritical fluid additive flow rate is out of range, when supercritical fluid additive supply is low, or when any measuring device (e.g., a thermocouple) is malfunctioning, amongst others. In addition, the control system may provide indication of any safety or operation alarm to the user.

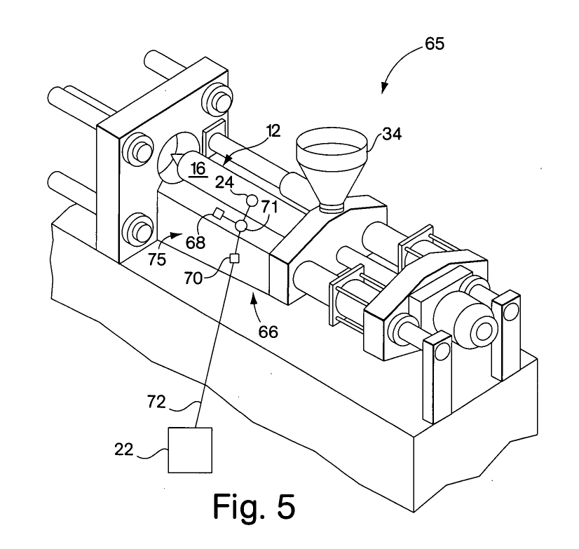

Referring to FIG. 5, in some embodiments, an injection molding system 65 includes a supercritical fluid additive introduction system 66 directly mounted to system 65, for example, to a frame 75 of extruder 12. Introduction system 66 can include metering device 39 which, in some cases, measures and meters the supercritical fluid additive flow rate and can optionally display the flow rate on a display 68. In other cases, metering device 39 does not measure, but only meters supercritical fluid additive flow. In other cases, the supercritical fluid additive can be measured and added volumetrically to the polymeric material. Optionally, introduction system 66 also includes a pump 70 which increases the pressure of the supercritical fluid additive above that in barrel 16 to permit introduction. The pump may or may not be directly mounted to the system. Source 22, which in the illustrative embodiment is separate (i.e., not permanently mounted) from system 65, supplies the supercritical fluid additive to introduction system 66 via conduit 72. The outlet of introduction system 66 is connected to port 24. The embodiment of FIG. 5 including the directly mounted introduction system can be advantageous by eliminating components (e.g., metering device 39) external of system 65. Thus, valuable floor space may be saved by using system 65.

As described above, systems and methods of the invention can be used to form solid or polymeric foam articles. Polymeric foam articles may be produced over a wide range of void fractions. Polymeric foams may be used that have a void fraction of between about 1% and about 99%. In some embodiments, higher density foams are used having a void fraction of less than 50%, in other cases a void fraction of less than 30%, and in some cases a void fraction of between about 5% and about 30%. The particular void fraction will depend upon the application.

In certain embodiments, microcellular material may be formed. Suitable microcellular materials have been described, for example, in International Publication No. WO 98/31521 (Pierick et. al.), referenced above. Microcellular materials, or microcellular foams, have small cell sizes and high cell densities. As used herein, the term “cell density” is defined as the number of cells per cubic centimeter of original, unfoamed polymeric material. As used herein, the term “average cell size” is the numerical average of the size of the cells formed in an article. The average cell size can be determined, for example, by scanning electron microscopy (SEM) analysis of a representative area of the article.

In some embodiments, the microcellular materials have an average cell size of less than 100 microns; in other embodiments, an average cell size of less than 50 microns; in other embodiments, an average cell size of less than 25 microns; in other embodiments, an average cell size of less than 10 microns; and, in still other embodiments, an average cell size of less than 1 micron. In some of these microcellular embodiments, the cell size may be uniform, though a minority amount of cells may have a considerably larger or smaller cells size. In certain cases, foam articles (including microcellular foams) may have a non-uniform cell size. In some of cases, different regions of the article may have cells of different size. For example, edge regions of the article may generally have a smaller cell size than interior regions of the article.

In some cases, the microcellular materials have a cell density of greater than 10⁶ cells/cm³, in others greater than 10⁷ cells/cm³, in others greater than 10⁸ cells/cm³, and in others greater than 10⁹ cells/cm³.

In another set of embodiments, polymeric articles are formed that approach, but do not achieve, the requirements of microcellular material. For example, articles may have at least 70% of the total number of cells in the polymeric portion have a cell size of less than 150 microns. In some embodiments at least 80%, in other cases at least 90%, in other cases at least 95%, and in other cases at least 99% of the total number of cells have a cell size of less than 150 microns. In other embodiments, the foam portion may be provided in which at least 30% of the total number of cells have a cell size of less than 800 microns, more preferably less than 500 microns, and more preferably less than 200 microns.

Any type of injection molded article can be produced using the systems and methods of the invention. The articles may generally comprise any type of polymeric material which can be injection molded. Suitable materials include thermoplastic polymers which may be amorphous, semicrystalline, or crystalline materials. Typical examples of polymeric materials include styrenic polymers (e.g., polystyrene, ABS), polyolefins (e.g., polyethylene and polypropylene), fluoropolymers, polyamides, polyimides, polyesters, polycarbonate, polyphenylene ether (PPE), thermoplastic elastomers, vinyl halides (e.g., PVC), acrylic (e.g., PMMA) and the like. The article may also include any number of other additives known in the art such as reinforcing agents, lubricants, plasticizers, colorants, fillers and the like. Optionally, the articles may include a nucleating agent, such as talc or calcium carbonate. In many embodiments, the articles are free of a nucleating agent. The articles are generally free of residual chemical blowing agents or reaction byproducts of chemical blowing agents. The articles are also generally free of non-atmospheric blowing agents, for example, when the supercritical fluid additive is an atmospheric component (e.g., nitrogen, carbon dioxide).

The function and advantages of these and other embodiments of the present invention will be more fully understood from the examples below. The following example is intended to illustrate the benefits of the present invention but does not exemplify the full scope of the invention.

### COMPARATIVE EXAMPLE

An 88-ton reciprocating screw injection molding machine manufactured by Arburg, Inc. (Newington, Conn.) was used to mold a spout insert for a bottle. The material used to make the spout insert was high density polyethylene (Fortiflex T50-2000-119, no filler, 20 g/10 min melt flow rate) manufactured by Solvay (Houston, Tex.). The mold used to mold the spout insert was a single cavity mold that was defined between two mold halves. The mold included a Husky (Bolton, Ontario) valve gate hot runner system. The system also included a source of supercritical additive (nitrogen) which was connected to the barrel of the injection molding machine. A valve provided the ability to shut-off flow of the supercritical additive into the injection molding machine to simulate a system that does not include a source of supercritical fluid additive.

Bottle 1 was formed using the system with the valve configured to prevent flow of supercritical fluid additive into the injection molding machine. Bottle 2 was formed using the system with the valve configured to allow flow of supercritical fluid additive into the injection molding machine. Bottle 1 was a solid article (non-foam) and Bottle 2 was a microcellular polymeric foam. The clamping force, injection pressure, and cycle time were measured for both bottles. The weight of both bottles and the average cell size of Bottle 2 was determined. The average cell size was determined by averaging the size of the cells in a representative cross-section as determined by SEM analysis. The results of the measurements are summarized in the table below.

| Measurement | BOTTLE 1 | BOTTLE 2 |
|---|---|---|
| Supercritical Fluid Additive (%) | 0 | 0.26 |
| Weight (g) | 8.0 | 7.2 |
| Void Fraction (%) | 0 | 10 |
| Clamping Force (tons) | 50 | 3 |
| Injection Pressure (psi) | 2200 | 1370 |
| Cycle Time (s) | 11.1 | 9.8 |
| Average Cell Size (micron) | no cells | 50 |

This example illustrates the ability to reduce clamping force and injection pressure using the supercritical fluid additive according to methods and systems of the invention. The clamping force was reduced from 50 tons to 3 tons (94%) and the injection pressure was reduced from 2200 psi to 1370 psi (38%) by using the supercritical fluid additive.

Those skilled in the art would readily appreciate that all parameters listed herein are meant to be exemplary and that the actual parameters would depend upon the specific application for which the methods and articles of the invention are used. It is, therefore, to be understood that the foregoing embodiments are presented by way of example only and that, within the scope of the appended claims and equivalence thereto, the invention may be practiced otherwise than as specifically described.

The different embodiments of the invention may or may not be used in combination with one another. For example, embodiments of the invention that utilize low clamping forces and/or low injection pressures may not utilize a control system. Also, embodiments of the invention that utilize a control system may not utilize low clamping forces and/or low injection pressures. However, it should also be understood that embodiments that utilize a control system may also utilize low clamping forces and/or injection pressures.

What is claimed is:

1. A polymeric material processing system comprising:
an extruder including a screw rotatable within a barrel to convey polymeric material in the direction of an outlet of the extruder, the barrel having a port formed therein;
a supercritical fluid additive introduction system having an inlet connectable to a supercritical fluid additive source and an outlet connectable to the port; and
a control system designed to receive inputs from the extruder and the supercritical fluid additive introduction system, and designed to send outputs to the extruder and the supercritical fluid additive introduction system to control, in part, operation of the extruder and the supercritical fluid additive introduction system.

2. The system of claim 1, wherein the control system includes a single controller.

3. The system of claim 1, wherein the control system includes a first controller associated with the extruder and a second controller associated with the supercritical fluid additive introduction system.

4. The system of claim 1, further comprising a mold defining a cavity connected to the outlet of the barrel.

5. The system of claim 4, further comprising a passageway that connects the mold to the outlet of the barrel and a shut-off nozzle valve positioned in the passageway, the shut-off valve having an open configuration which permits flow of polymeric material therethrough and a closed configuration which prevents flow of polymeric material therethrough.

6. The system of claim 5, wherein the control system receives an input indicative of the configuration of the shut-off nozzle valve.

7. The system of claim 5, wherein the control system sends an output to control the configuration of the shut-off nozzle valve.

8. The system of claim 5, wherein the shut-off nozzle valve has a heating unit associated therewith and the control system sends an output to control operation of the heating unit.

9. The system of claim 4, further comprising a hot runner gate within the mold, the hot runner gate including a valve.

10. The system of claim 9, wherein the control system sends an output to control the configuration of the hot runner gate valve.

11. The system of claim 1, wherein the extruder includes heating units mounted on the barrel, the control system sending an output to control the operation of the heating units.

12. The system of claim 11, wherein the control system sends an output to control the operation of the heating units based, at least in part, on an input from the extruder.

13. The system of claim 1, wherein the control system receives an input indicative of the axial position of the screw within the barrel.

14. The system of claim 1, wherein the control system sends an output to the extruder to control the axial position of the screw within the barrel.

15. The system of claim 1, wherein a passageway connects the inlet of the supercritical fluid additive introduction system to the outlet of the supercritical fluid additive introduction system.

16. The system of claim 15, wherein a bypass valve is positioned within the passageway of the supercritical additive introduction system, the bypass valve having a first configuration that permits flow of blowing agent from the inlet to the outlet and a second configuration that diverts flow of blowing agent from the inlet to the outlet.

17. The system of claim 16, wherein the control system sends an output to control the configuration of the bypass valve.

18. The system of claim 1, wherein the control system is designed to receive an input from an operator.

19. The system of claim 18, wherein the input from the operator activates the control system to enable the control system to send an output to the extruder to control pressure of polymeric material within the barrel.

20. The system of claim 18, wherein the supercritical fluid additive system includes an injector valve positioned between the inlet and the outlet, the injector valve having a first configuration which permits flow of blowing agent therethrough and a second configuration which prevents the flow of blowing agent therethrough, the input from the operator activating the control system to enable the control system to send an output to control the configuration of the injector valve.

21. The system of claim 18, wherein the operator provides an input to a first controller associated with the extruder, the first controller sending an output based on the input provided by the operator to a second controller associated with the supercritical fluid additive introduction system.

22. The system of claim 18, wherein the operator provides an input to a first controller associated with the supercritical fluid additive introduction system, the first controller sending an output based on the input provided by the operator to a second controller associated with extruder.

23. The system of claim 1, wherein the supercritical fluid additive system includes an injector valve positioned between the inlet and the outlet, the injector valve having a first configuration which permits flow of blowing agent therethrough and a second configuration which prevents the flow of blowing agent therethrough.

24. The system of claim 23, wherein the control system is designed to receive an input indicative of the configuration of the injector valve.

25. The system of claim 23, wherein the control system is designed to send an output to control the configuration of the injector valve.

26. The system of claim 1, wherein the control system is designed to receive an input indicative of the pressure of polymeric material within the barrel.

27. The system of claim 26, wherein the control system is designed to provide indication to an operator when the pressure of polymeric material within the barrel is greater or less, by an offset value, than a desired pressure.

28. The system of claim 27, wherein the offset value is ±200 psi.

29. The system of claim 26, wherein the polymeric material processing system is an injection molding system designed to operate in a series of molding cycles including a first molding cycle followed by a second molding cycle, the control system being designed to provide indication to an operator when the pressure of polymeric material within the barrel in the second cycle is greater or less, by an offset value, than the pressure of polymeric material within the barrel in the first molding cycle.

30. The system of claim 26, wherein the control system is designed to receive an input indicative of the pressure of polymeric material accumulated in a region within the barrel downstream of the screw.

31. The system of claim 1, wherein the control system is designed to send an output to the extruder to control the pressure of polymeric material within the barrel.

32. The system of claim 31, wherein the control system is designed to send an output to the extruder to control the pressure of polymeric material accumulated in a region within the barrel downstream of the screw.

33. The system of claim 1, wherein the control system is designed to receive an input indicative of the mass of supercritical fluid additive introduced into the polymeric material within the barrel.

34. The system of claim 33, wherein the control system is designed to provide indication to an operator when the mass of supercritical fluid additive introduced into the polymeric material within the barrel is greater or less, by an offset value, than a desired mass.

35. The system of claim 34, wherein the offset value is ±10 mg of the desired mass.

36. The system of claim 34, wherein the polymeric material processing system is an injection molding system designed to operate in a series of molding cycles including a first molding cycle followed by a second molding cycle, the control system being designed to provide indication to an operator when the mass of supercritical fluid additive introduced into the polymeric material is greater or less, by an offset value, than the mass of supercritical fluid additive introduced into the polymeric material in the first molding cycle.

37. The system of claim 1, wherein the control system is designed to send an output to the supercritical fluid additive introduction system to control the mass of supercritical fluid additive introduced into the polymeric material.

38. The system of claim 1, wherein the control system is designed to receive an input indicative of the delivery pressure of supercritical fluid additive introduced into the polymeric material within the barrel.

39. The system of claim 38, wherein the control system is designed to provide indication to an operator when the delivery pressure of supercritical fluid additive introduced into the polymeric material within the barrel is greater or less, by an offset value, than a desired delivery pressure.

40. The system of claim 39, wherein the offset value is ±50 psi.

41. The system of claim 39, wherein the polymeric material processing system is an injection molding system designed to operate in a series of molding cycles including a first molding cycle followed by a second molding cycle, the control system being designed to provide indication to an operator when the delivery pressure of supercritical fluid additive introduced into the polymeric material within the barrel in the second cycle is greater or less, by an offset value, than the delivery pressure of supercritical fluid additive introduced into the polymeric material within the barrel in the first molding cycle.

42. The system of claim 1, wherein the control system is designed to send an output to the extruder to control the delivery pressure of supercritical fluid additive introduced into the polymeric material.

43. The system of claim 1, wherein the control system includes a first controller associated with the extruder and a second controller associated with the supercritical fluid additive introduction system, the second controller sending an output to the supercritical fluid additive introduction system to not introduce supercritical fluid additive into polymeric material within the barrel in response to an input.

44. The system of claim 1, wherein the control system is designed to receive an input indicative of the rotational speed of the screw.

45. The system of claim 1, wherein the control system is designed to send an output to control the rotational speed of the screw.

46. The system of claim 4, wherein the control system is designed to receive an input from the mold.

47. A system for injection molding polymeric material comprising:
an extruder including a screw rotatable within a barrel to convey polymeric material in the direction of an outlet of the extruder, the barrel having a port formed therein connectable to a source of supercritical fluid additive; and
a clamping device constructed and arranged to clamp a mold defining a cavity connectable to the outlet of the extruder, the clamping device capable of providing a maximum clamping force of no greater than about 80% the minimum clamping force necessary to form an article from polymeric material free of a supercritical fluid additive within the cavity.

48. The system of claim 47, wherein the clamping device is capable of providing a maximum clamping force of no greater than about 65% the minimum clamping force necessary to form an article from polymeric material free of a supercritical fluid additive within the cavity.

49. The system of claim 47, wherein the clamping device is capable of providing a maximum clamping force of no greater than about 50% the minimum clamping force necessary to form an article from polymeric material free of a supercritical fluid additive within the cavity.

50. The system of claim 47, wherein the clamping device is capable of providing a maximum clamping force of no greater than about 30% the minimum clamping force necessary to form an article from polymeric material free of a supercritical fluid additive within the cavity.

51. The system of claim 47, wherein the clamping device is capable of providing a maximum clamping force of no greater than about 10% the minimum clamping force necessary to form an article from polymeric material free of a supercritical fluid additive within the cavity.

52. The system of claim 47, wherein the supercritical fluid additive comprises carbon dioxide.

53. The system of claim 47, wherein the supercritical fluid additive consists essentially of carbon dioxide.

54. The system of claim 47, wherein the supercritical fluid additive comprises nitrogen.

55. The system of claim 47, wherein the supercritical fluid additive consists essentially of nitrogen.

56. The system of claim 47, wherein the system is constructed and arranged to form a polymeric foam article.

57. The system of claim 47, wherein the system is constructed and arranged to form a microcellular material article.

58. The system of claim 57, wherein the microcellular material article has an average cell size of less than about 100 microns.

59. The system of claim 47, wherein walls of the mold have a thickness no less than about 10% thinner than mold walls necessary to form an article from polymeric material free of a supercritical fluid additive within the cavity.

60. The system of claim 47, wherein walls of the mold have a thickness no less than about 20% thinner than mold walls necessary to form an article from polymeric material free of a supercritical fluid additive within the cavity.

61. The system of claim 47, wherein the mold comprises aluminum.

62. The system of claim 47, wherein the screw is axially reciprocatable within the barrel from a first position to a second position.

63. The system of claim 62, further comprising an injection device constructed and arranged to move the screw in an axial direction from the first position to the second position within the barrel to inject a mixture of polymeric material and supercritical fluid additive into the cavity, the injection device capable of providing an injection pressure of no greater than about 80% the injection pressure necessary to form an article from polymeric material free of a supercritical fluid additive within the cavity.

64. The system of claim 63, wherein the injection device is capable of providing an injection pressure of no greater than about 65% the injection pressure necessary to form an article from polymeric material free of a supercritical fluid additive within the cavity.

65. The system of claim 64, wherein the injection device is capable of providing an injection pressure of no greater than about 50% the injection pressure necessary to form an article from polymeric material free of a supercritical fluid additive within the cavity.

66. The system of claim 47, further comprising a mold that includes a first mold half and a second mold half held together by the clamping force.

67. The system of claim 66, further comprising a first platen and a second platen, the first mold half being attachable to the first platen and the second mold half being attachable to a second platen, wherein at least one of the first and the second platens have a work surface area at least 10% greater than the work surface area of a platen usable to form an article from polymeric material free of a supercritical fluid additive within the cavity clamped with the clamping force.

68. A system for injection molding polymeric material comprising:
an extruder including a screw rotatable within a barrel to convey polymeric material in the direction of an outlet of the extruder, the barrel having a port formed therein connectable to a source of supercritical fluid additive;
a mold including a surface that defines, in part, a cavity connected to the outlet of the extruder, the mold surface that defines, in part, the cavity having a mold surface area; and
a clamping device constructed and arranged to clamp the mold with a clamping force necessary to form a molded article,
wherein the ratio of the clamping force to the mold surface area is less than about 1500 lbs/in².

69. The system of claim 68, wherein the ratio of the clamping force to the mold surface area is less than about 1000 lbs/in².

70. The system of claim 69, wherein the ratio of the clamping force to the mold surface area is less than about 750 lbs/in².

71. The system of claim 70, wherein the ratio of the clamping force to the mold surface area is less than about 500 lbs/in².

72. The system of claim 68, wherein the supercritical fluid additive comprises carbon dioxide.

73. The system of claim 68, wherein the supercritical fluid additive consists essentially of carbon dioxide.

74. The system of claim 68, wherein the source of supercritical fluid additive comprises nitrogen.

75. The system of claim 68, wherein the supercritical fluid additive consists essentially of nitrogen.

76. The system of claim 68, wherein the system is constructed and arranged to form a polymeric foam article.

77. The system of claim 76, wherein the system is constructed and arranged to form a microcellular material article.

78. The system of claim 77, wherein the microcellular material article has an average cell size of less than about 100 microns.

79. The system of claim 68, wherein the screw is axially reciprocatable within the barrel from a first position to a second position.

80. The system of claim 79, further comprising an injection device constructed and arranged to move the screw in an axial direction from the first position to the second position within the barrel to inject a mixture of polymeric material and supercritical fluid additive into the cavity, the injection device capable of providing an injection pressure of no greater than about 80% the injection pressure necessary to form an article from polymeric material free of a supercritical fluid additive within the cavity.

81. The system of claim 80, wherein the injection device is capable of providing an injection pressure of no greater than about 50% the injection pressure necessary to form an article from polymeric material free of a supercritical fluid additive within the cavity.

82. The system of claim 81, wherein the injection device is capable of providing an injection pressure of no greater than about 10% the injection pressure necessary to form an article from polymeric material free of a supercritical fluid additive within the cavity.

83. The system of claim 68, wherein walls of the first and second mold halves have a thickness no less than about 10% thinner than mold walls necessary to form an article from polymeric material free of a supercritical fluid additive within the cavity.

84. The system of claim 83, wherein walls of the first and second mold halves have a thickness no less than about 20% thinner than mold walls necessary to form an article from polymeric material free of a supercritical fluid additive within the cavity.

85. The system of claim 68, wherein the first and second mold halves comprise aluminum.

86. A system for injection molding polymeric material comprising:
an extruder including a screw rotatable within a barrel to convey polymeric material in the direction of an outlet of the extruder, the barrel having a port formed therein connectable to a source of supercritical fluid additive; and
a clamping device constructed and arranged to clamp a first mold half and a second mold half together with a clamping force, the first and second mold halves, when clamped together, defining a cavity connected to the outlet of the extruder;
a first platen attachable to the first mold half; and
a second platen attachable to the second mold half,
wherein the first and the second platens have a work surface area at least 10% greater than the work surface area of platens usable to form an article from polymeric material free of a supercritical fluid additive within the cavity clamped with the clamping force.

87. The system of claim 86, wherein the first platen is fixed.

88. The system of claim 86, wherein the second platen is movable.

89. The system of claim 86, wherein first and the second platens have a work surface area at least 30% greater than the work surface area of platens usable to form an article from polymeric material free of a supercritical fluid additive within the cavity clamped with the clamping force.

90. The system of claim 86, wherein first and the second platens have a work surface area at least 50% greater than the work surface area of platens usable to form an article from polymeric material free of a supercritical fluid additive within the cavity clamped with the clamping force.

91. A system for injection molding polymeric material comprising:
an extruder including a screw rotatable within a barrel to convey polymeric material in the direction of an outlet of the extruder, the barrel having a port formed therein connectable to a source of supercritical fluid additive; and
an injection device constructed and arranged to move the screw in an axial direction within the barrel to inject a mixture of polymeric material and supercritical fluid additive into a cavity of a mold connected to the outlet of the extruder, the injection device capable of providing an injection pressure of no greater than about 80% the injection pressure necessary to form an article from polymeric material free of a supercritical fluid additive within the cavity.

92. The system of claim 91, wherein the injection device is capable of providing an injection pressure of no greater than about 65% the injection pressure necessary to form an article from polymeric material free of a supercritical fluid additive within the cavity.

93. The system of claim 91, wherein the injection device is capable of providing an injection pressure of no greater than about 50% the injection pressure necessary to form an article from polymeric material free of a supercritical fluid additive within the cavity.

94. The system of claim 91, wherein the system is constructed and arranged to form a polymeric foam article.

95. The system of claim 94, wherein the system is constructed and arranged to form a microcellular material article.

96. The system of claim 94, further comprising a clamping device constructed and arranged to clamp the mold, the clamping device capable of providing a maximum clamping force of no greater than about 80% the minimum clamping force necessary to form an article from polymeric material free of a supercritical fluid additive within the cavity.

97. The system of claim 96, wherein the clamping device is capable of providing a maximum clamping force of no greater than about 50% the minimum clamping force necessary to form an article from polymeric material free of a supercritical fluid additive within the cavity.

98. The system of claim 97, wherein the clamping device is capable of providing a maximum clamping force of no greater than about 10% the minimum clamping force necessary to form an article from polymeric material free of a supercritical fluid additive within the cavity.

99. A system for injection molding polymeric material comprising:
an extruder including a screw rotatable within a barrel to convey polymeric material in the direction of an outlet of the extruder, the barrel having a port formed therein connectable to a source of supercritical fluid additive;
an injection device constructed and arranged to move the screw in an axial direction within the barrel to inject a mixture of polymeric material and supercritical fluid additive into a cavity of a mold connected to the outlet of the extruder, the injection device capable of providing an injection pressure of no greater than about 80% the injection pressure necessary to form an article from polymeric material free of a supercritical fluid additive within the cavity; and
a clamping device constructed and arranged to clamp the mold, the clamping device capable of providing a maximum clamping force of no greater than about 80% the minimum clamping force necessary to form an article from polymeric material free of a supercritical fluid additive within the cavity.

100. A system for processing polymeric material comprising:
an extruder including a screw rotatable within a barrel to convey polymeric material in the direction of an outlet of the extruder, the barrel having a port formed therein; and
a supercritical fluid additive introduction system having an inlet connectable to a supercritical fluid additive source and an outlet connectable to the port, the introduction system being directly mounted to the system.

101. The system of claim 100, wherein the introduction system is directly mounted to a frame of the extruder.

102. The system of claim 100, wherein the introduction system comprises a metering device.

103. The system of claim 100, wherein the supercritical fluid additive source is separate from the extruder.

104. The system of claim 100, further comprising a mold defining a cavity connected to the outlet of the extruder.

105. A method for forming a molded article comprising:
providing a polymeric material molding system including an extruder and a mold, the system constructed and arranged to deliver polymeric material free of supercritical fluid additive from the extruder into the mold and forming an injection molded article using a first minimum clamping force; and
delivering polymeric material admixed with a supercritical fluid additive from the extruder into the mold, and forming the injection molded article using a second minimum clamping force less than about 80% the first minimum clamping force.

106. A method for forming a molded article comprising:
introducing a polymeric material and supercritical fluid additive mixture into a mold;
clamping the mold with a clamping force of less than about 80% of the minimum clamping force required to form a molded article from the polymeric material free of the supercritical fluid additive; and
forming a molded article.
